(19) United States
(12) Patent Application Publication
(10) Pub. No.: US 2021/0204703 A1
(43) Pub. Date: Jul. 8, 2021

(54) VENUE SEATING ANTENNA APPARATUSES, SYSTEMS AND METHODS

(71) Applicants: James Martin, Midland, TX (US); F Hollister Keville, Piedmont, CA (US)

(72) Inventors: James Martin, Midland, TX (US); F Hollister Keville, Piedmont, CA (US)

(21) Appl. No.: 17/144,133

(22) Filed: Jan. 7, 2021

Related U.S. Application Data
(60) Provisional application No. 62/958,287, filed on Jan. 7, 2020.

(51) Int. Cl. A47C 7/72; H01Q 1/22; H01Q 1/44; A47C 1/124

(52) U.S. Cl. CPC A47C 7/72; A47C 1/124; H01Q 1/44; H01Q 1/2291

(57) ABSTRACT

A stadium or arena seat with one or more embedded or placed antennas for use in wireless communication infrastructure. The antennas can be accommodated in a recessed area of the seat, embedded directly in the seat, in the armrest structure or the seat, or components of the one or more antennas may be partially located externally to any the seat's surfaces.

### BACKGROUND

Embodiments of the inventive subject matter relate to systems, apparatuses and methods utilizing wireless communications systems and their antennas systems for wireless communication as deployed in stadiums and arenas. More particularly, embodiments relate to stadium, arena or other venue seats having one or more embedded antennas and/or antenna arrays to facilitate more effective wireless communication inside stadiums, arenas and other high capacity venues.

Prior art includes high capacity wireless communication systems that are typically deployed for use in stadiums and arenas to facilitate a satisfactory user experience. Some of these prior art systems consist of multiple antenna arrays designed above or behind the wireless system users with the intent to subdivide capacity into specific areas increasing wireless communication system capacity.

This prior art is limited in the capacity and quality of coverage that can be provided in these environments because of poor proximity to the wireless user and as such is limited in its application.

### SUMMARY

The illustrative embodiments provide concentrated deployment of antenna arrays within venues such as stadium and arena environments.

An objective of the inventive subject matter is to provide more robust coverage of the wireless communications in these types of environments by reducing the physical distance of the radiating element to the user's wireless device.

One embodiment includes a stadium or arena seat with one or more embedded or placed antennas for use in a wireless communication infrastructure.

Another embodiment further includes one or more additional antennas to the wireless infrastructure for additional connectivity.

Another embodiment further includes one or more antennas embedded in the stadium or arena seat back.

Another embodiment includes one or more antennas embedded in the stadium or arena seat surface.

Another embodiment includes one or more antennas embedded in one or both arm rests of the stadium or arena seat.

Another embodiment includes one or more radiating elements in one or both arm rests of the stadium or arena seat.

Another embodiment includes one or more radiating elements in a portion or substantially all of the supporting structure of the stadium or arena seat.

### DETAILED DESCRIPTION OF THE DRAWINGS

The novel features of the inventive subject matter, both as to its structure and its operation, will be best understood from the accompanying drawing, taken in conjunction with the accompanying description in which:

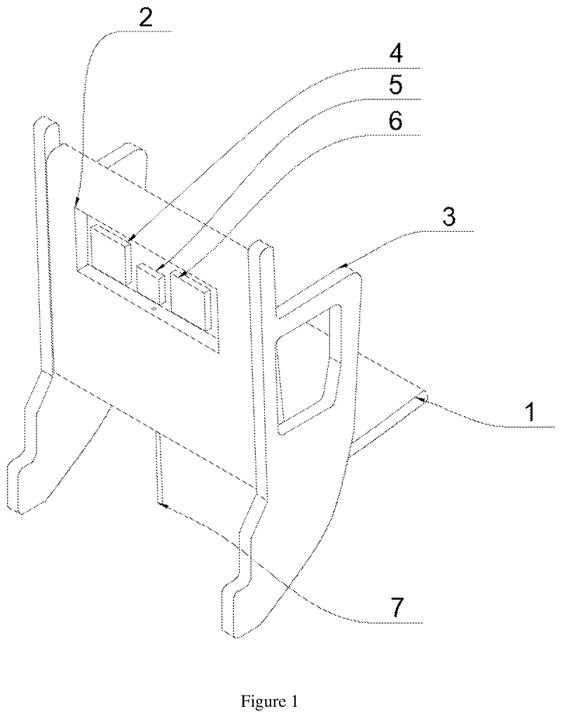

FIG. 1 is a perspective view of an embodiment utilizing a stadium/arena seat.

### DETAILED DESCRIPTION OF THE EMBODIMENTS

According to embodiments of the claimed subject matter, various apparatuses, systems and methods systems for utilizing wireless communications systems and their antennas systems for wireless communication as deployed in stadiums and arenas.

In one embodiment shown in FIG. 1, a wireless infrastructure is deployed in an exemplary seating structure. In this embodiment, the seat proper has a molded recess for a designated area 2 that can accommodate wireless antennas 4 and 6 within the seat structure. In other embodiments, the designated area 2 can be attached by any number of methods known to those skilled in the art including within a molded recess in the seat back or one or both of the armrests. In yet other embodiments, portions of the designated area 2 may accommodate one or more antennas and other portions exterior to the designated area 2 may accommodate one or more additional antennas.

In other embodiments, wireless antennas 4 and 6 may be a single antenna or they each may be comprised of more than one antenna. In some embodiments, the designated area 2 may not include a molded recess but it may be positioned or located in an external area.

The designated area 2 can be made to accommodate various sizes and types of antenna(s) and optional associated electronic equipment 5.

In some embodiments, the optional associated electrical equipment 5 can include any component know to those skilled in the art of wireless communication and wired or wireless power transfer technology.

In some embodiments, one or more antenna(s) can be embedded or contained in the seat structure or one or more of the armrests 3, the seat base 1 or another external surface. In many of these embodiments, the one or more antenna(s) can be constructed within one or more of the desired seat sections during the manufacturing process. In other embodiments, the one or more antenna(s) can be embedded or contained in an external attachment to the seat structure. Wi-Fi access points and portions of cellular distributed antenna system (DAS) deployments or any number of other suitable components known to those skilled in the art may be used with the present embodiments.

In many embodiments, a conduit 7 includes cabling for power and data connectivity to the one or more antennas. The power may be used to run electrical lines from a main power source to areas in the venue seat wherein the power can be connected to an additional venue seat outlet or port (not shown.) In other embodiments, the data connectivity can be used to connect additional relays or sensors that can be used in conjunction with the seat, for example to use in conjunction with an emergency button or trigger to track an emergency event or the data connectivity can be used in conjunction with the venue seat with any other suitable input or output device, for example one or more Bluetooth Low Energy (BLE) devices. Output devices may include one or more speakers or screens.

In the aforementioned embodiments, any suitable venue seat may be used with the integrated components and a portion of the components, including the input and output devices, may be positioned within the seat and exterior to the seat. For example, a mobile router may be included for providing a mobile network router configured for tracking information about data packets received from locally reachable devices and sent to public IP destination address over a cellular network.

Additional applications include the use of linear antenna arrays. In some embodiments, one or more of the antennas may be designed with a specific seat structure to accentuate specific patterns to aid in controlling signals such as when an antenna pattern possesses nulls in desired directions, which are widely used in smart antenna systems to eliminate the interference from specific noise directions. Many of the embodiments allow for the antennas to be configured to shape the pattern of the zone. In some embodiments, antenna arrays using beam forming or simulcasting aid in shaping traffic allocations and reducing interference in a deployed zone.

In these embodiments, one or more antennas can be self-optimizing so that the antenna output (ERP) is varied depending on the environment's requirements.

Some embodiments also include portions of the electronic components mounted beneath seats in used in public venues. Any suitable electronic components may be used known to those skilled in the art in arrangements with components of the described embodiments.

In other embodiments, the structure of the seat can be adapted for the venue, for example an airplane venue having embodiments positioned in one or more airplane seats, a bus venue with embodiments positioned in one or more bus seats, or in any suitable venue with a structural seating arrangement usable by a plurality of users.

In other embodiments, the data connectivity can aid in gathering enhanced location and/or position information about connected wireless device or any other suitable information gained from the device connected to the data connection. In use, embodiments may be used with specific sensors to detect and/or report acoustic firearm detection and laser sources. Other embodiments may be used to detect occupancy of a seat or provide a sensor to detect biometric data to confirm the identify of a seat occupant, for instance a season pass or other authorized ticket holder.

Many of the described embodiments can be used to retrofit venue seats without having to replace the structure of the entire seat, for example using an armrest, seatback or a seat to accommodate the components. While there have been shown what are presently considered to be embodiments of the inventive subject matter, it will be apparent to those skilled in the art skilled in the art that various changes and modifications can be made herein without departing from the spirit and the scope of the inventive subject matter.

What is claimed is:

1. A venue arena seat apparatus with one or more embedded antennas for use in a wireless communication infrastructure wherein a user can connect one or more devices to the one or more embedded antennas to communicate with the wireless communication infrastructure.

2. The venue arena seat apparatus of claim 1, further comprising one or more wireless power transfer technology devices.

3. The venue arena seat apparatus of claim 1, further comprising one or more wired power transfer technology devices.

4. The venue arena seat apparatus of claim 3, wherein said wired power transfer technology device is a USB port.

5. The venue arena seat apparatus of claim 1, wherein the one or more embedded antennas are placed antennas.

6. The venue arena seat apparatus of claim 1, wherein the wireless communication infrastructure is a WiFi network.

7. The venue arena seat apparatus of claim 1, wherein the one or more antennas are self-optimizing wherein the output of said antenna is varied depending on the environment's requirements.

8. The venue arena seat apparatus of claim 1, further comprising a data connectivity device for gathering enhanced location and/or position information about one or more connected wireless devices.

9. The venue arena seat apparatus of claim 1 further comprising sensors to detect one or more of the following: acoustic disturbances and laser sources.

10. A venue arena seat system comprising one or more embedded antennas for use in a wireless communication infrastructure wherein a user can connect one or more devices to the one or more embedded antennas to communicate with the wireless communication infrastructure.

11. The venue arena seat system of claim 10, further comprising one or more wireless power transfer technology devices.

12. The venue arena seat system of claim 10, further comprising one or more wired power transfer technology devices.

13. The venue arena seat system of claim 12, wherein said wired power transfer technology device is a USB port.

14. The venue arena seat system of claim 10, wherein the one or more embedded antennas are placed antennas.

15. The venue arena seat system of claim 10, wherein the wireless communication infrastructure is a WiFi network.

16. The venue arena seat system of claim 10, wherein the one or more antennas are self-optimizing wherein the output of said antenna is varied depending on the environment's requirements.

17. The venue arena seat system of claim 10, further comprising a data connectivity device for gathering enhanced location and/or position information about one or more connected wireless devices.

18. The venue arena seat system of claim 10 further comprising sensors to detect one or more of the following: acoustic disturbances and laser sources.
